(19) United States
(12) Patent Application Publication
(10) Pub. No.: US 2006/0257622 A1
(43) Pub. Date: Nov. 16, 2006

(54) Laminate for printed circuit board and method of manufacturing the same

(75) Inventors: Joon Sik Shin, Gyeonggi-do (KR); Cheol Ho Choi, Gyeonggi-do (KR); Kyoung Jin Son, Gyeonggi-do (KR); Geum Hee Yun, Gyeonggi-do (KR); Sang Youp Lee, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/356,495

(22) Filed: Feb. 17, 2006

(30) Foreign Application Priority Data
May 10, 2005 (KR) 10-2005-0039018
Jun. 10, 2005 (KR) 10-2005-0049862

(51) Int. Cl. B32B 3/10

(52) U.S. Cl. 428/137

(57) ABSTRACT

The present invention relates to a laminate for a printed circuit board, which is manufactured by incorporating woven fabric or nonwoven fabric formed of liquid crystal polyester fibers into a liquid crystal polyester resin, thus having a low dielectric constant and a low dissipation factor, suitable for use in the high frequency range (GHz or more), and exhibiting excellent thermal properties and high reliability, resulting in high processability.

### INCORPORATION BY REFERENCE

The present application claims priority under 35 U.S.C. §119 to Korean Patent Application Nos. 10-2005-0039018 filed on May 10, 2005 and 10-2005-0049862 filed on Jun. 10, 2005. The content of the applications is incorporated herein by reference in its entirety.

### BACKGROUND OF THE INVENTION

1. Field of the Invention

The present invention relates, generally, to a laminate for a printed circuit board IS (PCB) and a method of manufacturing the same, and more particularly, to a laminate for a PCB, which is manufactured by incorporating woven fabric or nonwoven fabric formed of liquid crystal polyester fibers into a liquid crystal polyester resin, thus having a low dielectric constant and a low dielectric dissipation factor, even in a high frequency range, and exhibiting excellent thermal properties, and to a method of manufacturing such a laminate for a PCB.

2. Description of the Related Art

Typically, prepregs and copper clad laminates (CCLs) for use in packaging substrates have been mainly manufactured using BT (Bismaleimide Triazine) resin and epoxy resin (e.g., high Tg FR-4).

In addition, BT or epoxy resin (e.g., varnish) is incorporated with glass fabric to prepare a B-stage prepreg. The prepreg thus prepared along with a copper foil is laminated to have multiple layers, heated, and compressed, thus fabricating a CCL.

As such, the use of BT resin is preferable to the use of epoxy resin. This is because the BT resin has thermal properties (high Tg), electrical properties, and peel strength with copper foil, superior to those of the epoxy resin, and is structurally stable.

Of these properties, in particular, thermal properties (Tg) are regarded to be the most important. The reason is that a packaging substrate should be highly reliable. That is, since a coefficient of thermal expansion (CTE) varies at temperatures lower and higher than Tg, brittleness and warpage of the packaging substrate may be generated by non-uniform volume contraction in the process. During fabrication processes, non-uniform thermal expansion and thermal contraction are repeated at temperatures lower and higher than Tg, thus residual stress occurs, resulting in delamination and warpage of final products.

A conventional packaging material having the above properties is manufactured by incorporating glass fabric (e.g., E-glass type glass fabric), having a low coefficient of thermal expansion but a high dielectric constant of about 6.2, into the BT or epoxy resin. Hence, a dielectric constant thereof is as large as 3.5-4, and a dissipation factor is also large. Consequently, the conventional packaging material is difficult to use in the high frequency range (GHz).

To overcome this problem, a lot of effort continues to be directed to the following two types, that is, the development of a substrate material to substitute for glass fabric, having an excellent coefficient of thermal expansion but a high dielectric constant and dissipation factor, and of a substrate material having a low dielectric constant and dissipation factor to substitute for BT or epoxy resin.

First, in order to substitute for glass fabric, methods of manufacturing a substrate material have been proposed, including incorporating liquid crystal polymer nonwoven fabric having a low dielectric constant and dissipation factor into a conventional BT or epoxy resin. This method is advantageous because the high dielectric constant and dissipation factor of glass fabric may be greatly decreased, but suffers because the BT or epoxy resin has too high a dielectric constant, unsuitable for use in the high frequency range, and the dissipation factor thereof increases, and thus rapid thermal expansion occurs at a temperature higher than Tg (about 180° C.).

Second, methods of manufacturing a substrate material, using glass fabric having superior coefficient of thermal expansion and Teflon as an insulating material having a dielectric constant and a dissipation factor much lower than those of the BT or epoxy resin, have been proposed. In this case, the substrate material thus manufactured has a low dielectric constant and dissipation factor, and an excellent coefficient of thermal expansion, but is expensive and has poor processability.

Meanwhile, a thermoplastic liquid crystal polymer is receiving attention as an alternative material to polyimide used in FCCL (flexible copper clad laminate) which is a flexible and rigid & flexible PCB material. The reason is that the liquid crystal polymer s5 can overcome the drawbacks (high water absorption rate, dimensional instability, and a high dielectric constant (Dk) and dissipation factor (Df)) of polyimide. In addition, the liquid crystal polymer has a low dielectric constant and dissipation factor even in the high frequency range (GHz), thereby exhibiting excellent electrical properties.

Hence, thorough attempts have been made to apply liquid crystal polymers as substrate material and interlayer insulating material to substitute for polyimide conventionally used in flexible and rigid & flexible PCBs, relying on the excellent electrical properties, such as a low dielectric constant and a low dissipation factor, and a low coefficient of thermal expansion of the liquid crystal polymer.

Particularly, chemical companies in Japan and the USA have produced FCCLs and insulating films to date, and have studied along with PCB manufacturers the application and development of such laminates and films to the high frequency range (GHz) and the next generation of flexible and rigid & flexible PCBs. In addition, research into the use of liquid crystal polymers having such excellent properties for packaging substrates is under study.

However, when the liquid crystal polymer having excellent properties is used alone, stiffness becomes insufficient. Thus, the polymer may be limitedly used only in flexible and rigid & flexible PCBs, and is difficult to apply to semiconductor packaging substrates.

Therefore, there is urgently required the development of a new type of packaging substrate material having a low dielectric constant and dissipation factor suitable for use in the high frequency range, a low coefficient of thermal expansion, high reliability, a low price, and excellent processability.

### SUMMARY OF THE INVENTION

Accordingly, the present invention has been made keeping in mind the above problems occurring in the related art, and an object of the present invention is to provide a laminate for a PCB, in which liquid crystal polymer woven fabric or liquid crystal polymer nonwoven fabric is used as a reinforcing material in a liquid crystal polymer resin to overcome low stiffness, regarded as a disadvantage of a liquid crystal polymer, while maximizing the advantages thereof, for application to a packaging substrate.

Another object of the present invention is to provide a method of manufacturing such a laminate for a PCB.

According to an aspect of the present invention for achieving the above objects, a laminate for a PCB is provided, which is manufactured by incorporating woven fabric or non-woven fabric formed of liquid crystal polyester fibers having a dielectric constant of 2.5-3.0 and a liquid crystal melting point of 260-350° C. into a liquid crystal polyester resin having a liquid crystal melting point of 280-360° C.

In the laminate of the present invention, the liquid crystal melting point of the liquid crystal polyester resin is preferably lower than the liquid crystal melting point of the liquid crystal polyester fiber.

In addition, the liquid crystal polyester resin preferably includes repeating units represented by Formulas 1, 2, 3 and 4 below, in which the repeating unit of Formula 1 is used in an amount of 20-70 mol %, the repeating unit of Formula 2 is used in an amount of 7-30 mol %, the repeating unit of Formula 3 is used in an amount of 7-30 mol %, and the repeating unit of Formula 4 is used in an amount of 7-30 mol %, based on the amount of the liquid crystal polyester resin:
—O—Ar₁—CO— Formula 1
—CO—Ar₂—CO— Formula 2
—O—Ar₃—O— Formula 3
—X—Ar₄—Y— Formula 4

in Formulas 1 to 4, Ar₁ to Ar₄, which are each independently a C₆-C₁₂ aryl group, X is —NH—, and Y is —O— or —NH—.

In addition, the liquid crystal polyester fiber preferably has an average thickness of 1-15 μm.

In addition, the laminate preferably includes 5-60 wt % of the incorporated woven fabric or non-woven fabric formed of liquid crystal polyester fibers.

In addition, the laminate may further include a filler selected from a group consisting of silica, alumina, titania, calcium carbonate, carbon, graphite, and mixtures thereof.

According to another aspect of the present invention, a method of manufacturing a laminate for a PCB is provided, the method includes the steps of providing woven fabric or non-woven fabric formed of liquid crystal polyester fibers having a dielectric constant of 2.5-3.0 and a liquid crystal melting point of 260-350° C.; incorporating the woven fabric or nonwoven fabric formed of liquid crystal polyester fibers into a liquid crystal polyester solution including a solvent and a liquid crystal polyester resin having a liquid crystal melting point of 280-360° C., to obtain incorporated liquid crystal polyester woven fabric or nonwoven fabric; drying the incorporated liquid crystal polyester woven fabric or nonwoven fabric; and laminating the dried liquid crystal polyester woven fabric or nonwoven fabric to have multiple layers, and then heating and compressing the laminated liquid crystal polyester woven fabric or nonwoven fabric.

In the method of the present invention, it is preferable that drying step be conducted at 50-200° C. for 0.5-2 hr, and the laminating step be conducted at 200-400° C. for 0.5-4 hr.

In addition, the drying and laminating steps are preferably conducted in an inert atmosphere.

According to a further aspect of the present invention, a CCL, manufactured by laminating a copper foil on at least one surface of the laminate of the present invention, is provided.

According to still another aspect of the present invention, a PCB, including an outer circuit layer, at least one inner circuit layer, and an insulating layer having a through hole therein for electrical connection between the circuit layers, in which the insulating layer is the laminate of the present invention, is provided.

### BRIEF DESCRIPTION OF THE DRAWINGS

FIG. 1 is a view sequentially showing a process of manufacturing a laminate for a PCB, according to the present invention; and

FIG. 2 is a view sequentially showing a process of manufacturing a CCL using the laminate for a PCB, according to the present invention.

### DETAILED DESCRIPTION OF THE INVENTION

Hereinafter, a detailed description will be given of the present invention, with reference to the appended drawings.

Based on the present invention, a new type of substrate material is provided, which is advantageous because it has a low dielectric constant and dissipation factor, suitable for use in the high frequency range, thanks to the use of liquid crystal polymer resin and liquid crystal polymer woven fabric or liquid crystal polymer nonwoven fabric. In addition, such a substrate material has low water absorption rate, excellent dimensional stability, and superior thermal properties. Therefore, the substrate material of the present invention is expected to greatly affect high functionality and miniaturization of PCBs in the future.

For reference, main properties of liquid crystal polyester, polyimide, BT and epoxy used as the substrate material are summarized in Table 1 below.

TABLE 1

| | | | | Packaging | |
|---|---|---|---|---|---|
| | | Flexible PCB | | Substrate | |
| | | Liquid Crystal | | | High Tg |
| | | Polymer | Polyimide | BT | Epoxy |
| Water Absorption (%) | | <0.1 | 1.3-1.5 | 0.35 | 0.36 |
| CTE (<Tg), | X | 17 | 20 | 15 | 13.9 |
| ppm/% RH | Y | 17 | 20 | 15 | 15.1 |
| | Z | — | — | 45 | 55 |

| | | | | |
|---|---|---|---|---|
| CHE ppm/% RH | <5 | 28 | — | — |
| Dk @ 1 GHz | 2.8-3.0 | 3.3-3.5 | 4.7 | 4.2 |
| Df @ 1 GHz | 0.002-0.003 | >0.01 | 0.013 | 0.019 |

Note:
CTE: coefficient of thermal expansion,
CHE: coefficient of hygroscopic expansion,
Dk: dielectric constant,
Df: dissipation factor.

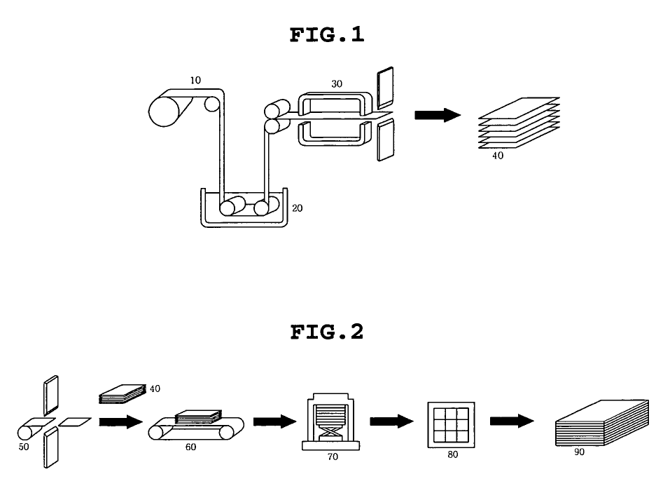

Referring to FIG. 1 illustrating a process of manufacturing a laminate for a PCB according to the present invention, the manufacturing method of the laminate for a PCB of the present invention is described below.

First, woven fabric or nonwoven fabric formed of liquid crystal polyester fibers is prepared in a liquid crystal polyester woven fabric or nonwoven fabric feeding part 10.

The liquid crystal polyester fiber, which is incorporated as a reinforcing material into a liquid crystal polyester resin described below to exhibit appropriate modulus properties, excellent drill processability, a low dielectric constant, a low dissipation factor, and superior thermal properties, has an average thickness of 1-15 μm, a dielectric constant of 2.5-3.0 and a liquid crystal melting point of 260-350° C., and preferably 320-350° C. Such liquid crystal polyester fiber has stiffness suitable for use in packaging materials, as well as high heat resistance, a low dielectric constant, low water absorption rate, etc. Thus, the problems (high dielectric constant and dissipation factor) of presently available glass fabric can be overcome.

The liquid crystal polyester fiber is not particularly limited, and any material known in the art may be used as long as it sufficiently satisfies the above-mentioned required properties.

Then, the woven fabric or nonwoven fabric formed of polyester fibers is incorporated into a liquid crystal polyester solution including a solvent and a liquid crystal polyester resin having a liquid crystal melting point of 280-360° C. in a liquid crystal polyester solution incorporation part 20.

Although the solvent is not particularly limited, an aprotic solvent or a solvent containing a halogen atom may be preferably used. The amount of the solvent used is not particularly limited as long as it dissolves the liquid crystal polyester resin, and may be appropriately determined depending on uses thereof. The liquid crystal polyester is used in an amount of 1-100 parts by weight, and preferably, 5-15 parts by weight, suitable for the exhibition of workability and economic benefits, based on 100 parts by weight of the solvent.

The melting point of the liquid crystal polyester resin ranges from 280 to 360° C., and preferably from 300 to 320° C., so that not only the dielectric constant and dissipation factor but also the coefficient of thermal expansion at temperatures lower and higher than Tg are maintained low. In particular, the liquid crystal polyester resin should have a melting point lower than the liquid crystal polymer fibers to be incorporated, to enable heat treatment of the woven fabric or nonwoven fabric formed of liquid crystal polymer fibers, without change of physical properties thereof, at a temperature not lower than a heat deformation temperature of liquid crystal polymer resin upon fabrication of a laminate through subsequent procedures for pre-drying, lamination and heat treatment at high temperatures.

The liquid crystal polyester resin is not particularly limited as long as it sufficiently satisfies the required properties as mentioned above. Preferably, the liquid crystal polyester resin has repeating units represented by Formulas 1, 2, 3 and 4 below:
—O—Ar₁—CO— Formula 1
—CO—Ar₂—CO— Formula 2
—O—Ar₃—O— Formula 3
—X—Ar₄—Y—. Formula 4

In Formulas 1 to 4, Ar₁ to Ar₄, which are each independently a C₆-C₁₂ aryl group, X is —NH—, and Y is —O— or —NH—.

Preferably, the liquid crystal polyester resin includes 20-70 mol % of the repeating unit of Formula 1, 7-30 mol % of the repeating unit of Formula 2, 7-30 mol % of the repeating unit of Formula 3, and 7-30 mol % of the repeating unit of Formula 4, suitable for the exhibition of the required properties.

In addition, the incorporation time is not particularly limited, but is appropriately controlled to manufacture the laminate including 5-60 wt % of the incorporated woven fabric or nonwoven fabric formed of liquid crystal polyester fibers.

With the goal of decreasing the coefficient of thermal expansion and water absorption rate and increasing the modulus, the liquid crystal polyester solution may further include a filler, if necessary. In addition, additives, including a compatibilizer, a dye, a pigment, an antistatic agent, etc., may be further included.

The filler is selected from among inorganic materials, such as silica, alumina, titania, calcium carbonate, etc., organic materials, such as carbon, graphite, etc., and mixtures thereof. The filler preferably has an average particle size of 0.1-10 μm. If the filler has an average particle size exceeding the upper limit, agglomeration may easily occur and surface flatness may be degraded. The filler is used in an amount of 5-60 vol %, and preferably 10-40 vol %, based on the amount of the liquid crystal polyester solution, to realize economic benefits and exhibit the required properties.

Subsequently, the incorporated liquid crystal polyester woven fabric or nonwoven fabric is pre-dried at 50-200° C. for 0.5-2 hr, and preferably at 100-150° C. for 1-2 hr, laminated to have multiple layers and to be as thick as desired, and heated and compressed at 200-400° C. for 0.5-4 hr, and preferably at 200-280° C. for 1-2 hr, completely dried and heat treated to remove the solvent in a drying part 30, thus obtaining a final laminate 40.

When the laminate 40 is manufactured, copper foils are laminated on one surface or both surfaces of the laminate using a process known to those skilled in the art, to fabricate a copper clad laminate.

As such, the heating, compression and heat treatment processes should be conducted, in consideration of all melting points of the liquid crystal polyester woven fabric or nonwoven fabric and the liquid crystal polyester resin.

That is, in order to vary thickness, improve adhesive strength and prevent delamination and cracking of a substrate, the heat treatment process is performed at a temperature not lower than a heat deformation temperature, that is, a melting point, of the liquid crystal polyester resin, whereas the lamination process may be conducted at a temperature not higher than a heat deformation temperature, that is, a melting point, of the liquid crystal polyester resin, if necessary. Thus, the temperature of the heat treatment process should be appropriately set in consideration of all melting points of the liquid crystal polyester woven fabric or nonwoven fabric and the liquid crystal polyester resin, depending on necessary purposes.

The drying process is conducted in an air atmosphere or an inert atmosphere such as nitrogen, and is preferably conducted in an inert atmosphere.

If the pre-drying process is carried out at too high a temperature, contraction or warpage may occur due to the rapid solvent evaporation. In addition, in the lamination and heat treatment processes, it is noted that heating and compression at too high a temperature result in change of physical properties of the liquid crystal polyester woven fabric or nonwoven fabric.

Since a conventional prepreg is in a non-cured B-stage, curing and lamination processes must be conducted through heating and compression at a high temperature for a long period of time. However, in the case where the liquid crystal polymer resin is used according to the method of the present invention, the liquid crystal polymer resin has thermoplastic properties, and thus it is possible to conduct lamination through heating and compression in a short time. Thereby, fabrication costs and time may be reduced.

In addition, although the non-cured B-stage prepreg conventionally used suffers because it may be stored only for about 3 months because of the deformation of products, the laminate of the present invention can be easily handled, without deformation problems.

Further, the liquid crystal polymer of the present invention may thermally expand at a temperature higher than Tg. However, the degree of such expansion is much less than that of typical thermosetting resins. Moreover, a filler is selectively used, resulting in a decreased coefficient of thermal expansion. As well, the water absorption rate is decreased and the modulus is increased.

The CCL or the laminate of the present invention is applied to typical PCB fabrication processes and thus may serve as substrates for outer or inner layers, or as insulating layers between circuit layers.

Turning now to FIG. 2, the process of manufacturing a CCL using the laminate of the present invention is illustrated.

A plurality of laminates 40, along with about 18 μm or thinner copper foils (e.g., electrodeposited copper foil or rolled copper foil) having surface roughness fed in a copper foil feeding part 50, is laminated in a building-up part 60, heated and compressed using heating and compression means, such as a V-press or a heat roll, in a heating and compression part 70, and trimmed for final inspection in a trimming part 80, to manufacture CCLs 90 having various thicknesses.

In this way, the substrate material of the present invention, having excellent properties, can be manufactured in the same manner as in a conventional method of manufacturing a substrate material (prepreg and CCL), while using conventional processes unchanged without additional processes.

In addition, the laminate or CCL of the present invention, manufactured by using the liquid crystal polymer resin and the liquid crystal polyester woven fabric or nonwoven fabric, is advantageous because it has a dielectric constant and a dissipation factor much lower than those of conventional thermosetting resins, and is thus possible to use in the high frequency range. Further, the laminate or CCL has a very low coefficient of thermal is expansion, thereby satisfying high reliability required for packaging substrate materials.

As well, for the assurance of flame retardancy, the substrate material of the present invention does not contain bromine (Br) or chlorine (Cl) conventionally used in epoxy resins, and is thus halogen free. In addition, the inventive material has excellent heat resistance and may be Pb free, depending on the restriction of use of Pb for soldering. Therefore, the substrate material of this invention is regarded to be environmentally friendly.

Further, disadvantages of conventional laminates including epoxy resin and glass fabric, such as poor drill processability (drill wear), powder (which causes impurities and opens/shorts), generated when processing using a drill or a router, are overcome.

A better understanding of the present invention may be obtained in light of the following examples which are set forth to illustrate, but are not to be construed to limit the present invention.

### EXAMPLE 1

10 parts by weight of a liquid crystal polyester resin having a liquid crystal melting point of about 300° C. was dissolved in 100 parts by weight of N-methyl pyrrolidone as a solvent, to prepare a liquid crystal polyester solution. Into the solution thus prepared, nonwoven fabric (VECRUS, available from Kuraray) formed of liquid crystal polyester fibers, having an average thickness of about 10 μm, a dielectric constant of 2.8 and a liquid crystal melting point of about 330° C., was incorporated at room temperature for about 8 min. The incorporated nonwoven fabric was pre-dried at about 100° C. for about 1 hr in a nitrogen atmosphere, heated and compressed along with a copper foil at about 250° C. for 2 hr, heat treated and then completely dried, to manufacture a CCL of the present invention. The dielectric constant, dissipation factor, coefficient of thermal expansion, and water absorption rate of the CCL thus manufactured were measured. The results are given in Table 2 below.

### COMPARATIVE EXAMPLE 1

A CCL was manufactured in the same manner as in Example 1, with the exception that BT varnish was used instead of the liquid crystal polyester solution. The dielectric constant, dissipation factor, coefficient of thermal expansion, and water absorption rate of the CCL thus manufactured were measured. The results are given in Table 2 below.

### COMPARATIVE EXAMPLE 2

A CCL was manufactured in the same manner as in Example 1, with the exception that epoxy varnish was used instead of the liquid crystal polyester solution. The dielectric constant, dissipation factor, coefficient of thermal expansion, and water absorption rate of the CCL thus manufactured were measured. The results are given in Table 2 below.

### COMPARATIVE EXAMPLE 3

A CCL was fabricated in the same manner as in Example 1, with the exception that PTFE varnish and glass fabric were used instead of the liquid crystal polyester solution and the nonwoven fabric formed of liquid polyester fibers, respectively. The dielectric constant, dissipation factor, coefficient of thermal expansion, and water absorption rate of the CCL thus manufactured were measured. The results are given in Table 2 below.

TABLE 2

| | Ex. 1 | C. Ex. 1 | C. Ex. 2 | C. Ex. 3 |
|---|---|---|---|---|
| Dk @ 1 GHz | <2.8 | 3.1-3.3 | 2.9-3.1 | 2.6 |
| Df @ 1 GHz | <0.0015 | 0.0035 | 0.0027 | 0.002 |
| CTE | 18 | 20-30 | 20-30 | 9.5 |
| Water Absorption | <0.02 | 0.18 | 1.2 | <0.02 |

As is apparent from Table 2, the CCL (Comparative Example 1) resulting from the use of BT resin and liquid crystal polyester nonwoven fabric and the CCL (Comparative Example 2) resulting from the use of epoxy resin and liquid crystal polyester nonwoven fabric had high coefficients of thermal expansion, high dielectric constants, and high dissipation factors, and thus were unsuitable for use in the high frequency ranges. In addition, the CCL (Comparative Example 3) resulting from the use of PTFE resin and glass fabric had a low dielectric constant, a low dissipation factor, and low water absorption rate, but had high manufacturing costs, poor processability, and low adhesive strength. If this CCL is applied to manufacture a multi-layered PCB, it may cause problems. However, the CCL (Example 1) resulting from the use of liquid crystal polyester resin and liquid crystal polyester nonwoven fabric had low dielectric constant and dissipation factor, and excellent thermal properties and processability.

The embodiments of the present invention, regarding the laminate for a PCB and the manufacturing method thereof, have been disclosed for illustrative purposes, but are not to be construed to limit the present invention, and those skilled in the art will appreciate that various modifications, additions and substitutions are possible, without departing from the spirit of the invention.

As described above, the present invention provides a laminate for a PCB and a method of manufacturing the same. According to the present invention, when a laminate is manufactured, liquid crystal polyester resin and liquid crystal polyester woven fabric or nonwoven fabric are used, instead of thermosetting resins (BT, epoxy) and glass fabric as conventional packaging substrate materials. Thereby, both a dielectric constant and a dissipation factor are decreased, and the laminate of the present invention is thus suitable for use in the high frequency range. In addition, the coefficient of thermal expansion is low at a temperature higher than Tg and processability is superior, therefore manufacturing a highly reliable laminate.

The laminate of the present invention can be expected to be used in the high frequency range and be suitable for application to semiconductor packaging substrates requiring high reliability, based on the improved properties thereof.

Many modifications and variations of the present invention are possible in light of the above teachings, without departing from the scope and spirit of the invention as disclosed in the accompanying claims.

What is claimed is:

1. A laminate for a printed circuit board, manufactured by incorporating at least one of a woven fabric and non-woven fabric formed of liquid crystal polyester fibers, having a dielectric constant of 2.5-3.0 and a liquid crystal melting point of 260-350° C., into a liquid crystal polyester resin having a liquid crystal melting point of 280-360° C.

2. The laminate as set forth in claim 1, wherein the liquid crystal melting point of the liquid crystal polyester resin is lower than the liquid crystal melting point of the liquid crystal polyester fiber.

3. The laminate as set forth in claim 1, wherein the liquid crystal polyester resin comprises —O—Ar₁—CO—, —CO—Ar₂—CO—, —O—Ar₃—O—, and —X—Ar₄—Y—, in which the —O—Ar₁—CO— is used in an amount of 20-70 mol %, the —CO—Ar₂—CO— is used in an amount of 7-30 mol %, the —O—Ar₃—O— is used in an amount of 7-30 mol %, and the —X—Ar₄—Y— is used in an amount of 7-30 mol %, based on an amount of the liquid crystal polyester resin:
wherein, Ar₁ to Ar₄ are each independently a C₆-C₁₂ aryl group, X is —NH—, and Y is —O— or —NH—.

4. The laminate as set forth in claim 1, wherein the liquid crystal polyester fiber has an average thickness of 1-15 μm.

5. The laminate as set forth in claim 1, wherein the laminate comprises 5-60 wt % of the incorporated fabric formed of liquid crystal polyester fibers.

6. The laminate as set forth in claim 1, further comprising a filler selected from a group consisting of silica, alumina, titania, calcium carbonate, carbon, graphite, and mixtures thereof.

7. A method of manufacturing a laminate for a printed circuit board, comprising the steps of:
providing at least one of a woven fabric and non-woven fabric formed of liquid crystal polyester fibers having a dielectric constant of 2.5-3.0 and a liquid crystal melting point of 260-350° C.;
incorporating the fabric formed of liquid crystal polyester fibers into a liquid crystal polyester solution comprising a solvent and a liquid crystal polyester resin having a liquid crystal melting point of 280-360° C., to obtain incorporated liquid crystal polyester fabric;
drying the incorporated liquid crystal polyester fabric; and
laminating the dried liquid crystal polyester fabric to have multiple layers, and heating and compressing the laminated liquid crystal polyester fabric.

8. The method as set forth in claim 7, wherein the laminate comprises 5-60 wt % of the incorporated fabric formed of liquid crystal polyester fibers.

9. The method as set forth in claim 7, wherein the drying step is conducted at 50-200° C. for 0.5-2 hr.

10. The method as set forth in claim 7, wherein the laminating step is conducted at 200-400° C. for 0.5-4 hr.

11. The method as set forth in claim 7, wherein the drying and laminating steps are conducted in an inert atmosphere.

12. A copper clad laminate, manufactured by laminating a copper foil on at least one surface of the laminate of claim 1.

13. A printed circuit board, comprising an outer circuit layer, at least one inner circuit layer, and an insulating layer having a through hole therein for electrical connection between the circuit layers, in which the insulating layer is the laminate of claim 1.
